(19) United States
(12) Patent Application Publication
(10) Pub. No.: US 2004/0260843 A1
(43) Pub. Date: Dec. 23, 2004

(54) Peripheral device card bridging device

(76) Inventor: Peter T. Sleeman, Horndean (GB)

Correspondence Address: Don W. Bulson, Esq., Renner, Otto, Boisselle & Sklar, P.L.L., 19th Floor, 1621 Euclid Ave., Cleveland, OH, 44115, US

(21) Appl. No.: 10/601,433

(22) Filed: Jun. 23, 2003

(51) Int. Cl. G06F 3/00

(52) U.S. Cl. 710/8; 710/11

(57) ABSTRACT

A peripheral device card conformant to a Personal Computer Memory Card International Association (PCMCIA) standard. The peripheral device card having a single semiconductor package bridging device containing an area of non-volatile attribute memory for storing a card information structure and an area of bus decode logic for decoding accesses to the attribute memory. By combining attribute memory and bus decode logic, PCMCIA conformant cards with increased space available for further functional circuitry are provided. The bridging device may include further circuitry, such as universal asynchronous receiver/transmitter (UART) circuitry, so as to provide a single package functional yet flexible building block which can be used in the design and construction of peripheral device cards with a wide range of different functions.

### BACKGROUND OF THE INVENTION

The invention relates to peripheral device cards. A peripheral device card is an electronic card that allows a user to add a peripheral device to a host computer. Many peripheral device cards are conformant to a Personal Computer Memory Card International Association (PCMCIA) standard. Conformant cards are often referred to as PCMCIA cards, or more simply as PC-cards. Further variants include compact flash (CF) cards, CardBus cards, Miniature cards, Cardbay cards, SmartMedia cards and Newcard cards.

PC-cards mainly come in one of three form factors. Each form factor has a surface area of 86 mm×54 mm and a thickness of one of 3.3 mm, 5 mm or 10.5 mm. CF-cards are a subset of the PCMCIA standard and do not conform to any of these three PC-card form factors. A CF-card is approximately half the size of a PC-card and uses a reduced electrical interface. However, mounting adapters are readily available for converting CF-cards to one of the PC-card form factors. CardBus cards are also subset of the PCMCIA standard and they do conform to the main PC-card form factors. However, CardBus cards provide a 32-bit electrical interface similar to that of a peripheral component interconnect (PCI) bus rather than the 16-bit electrical interface of PC-cards. CardBus card interfaces therefore provide enhanced throughput over PC-card and CF-card interfaces.

Most current computers have a single or dual card receiving slot which is compatible with the PCMCIA standard. These slots are generally able to accept all the above-mentioned cards and form factors (with CF-cards mounted in a suitable adapter). For simplicity, the term ‘PC-card’ will hereinafter be used to refer to all types of peripheral device card, including CF-cards, CardBus cards, Miniature cards, Cardbay cards, SmartMedia cards and Newcard cards, unless the context demands otherwise.

There are many types of PC-card currently available. PC-cards offer a multitude of enhancement options and additional functionality which can readily be added to personal computers. The availability of a large number of different devices as PC-cards makes it necessary for a host computer's operating system to be able to identify the type and operating function of a PC-card connected to it. Accordingly, the PCMCIA standard provides for a data structure, called a Card Information Structure (CIS), which is built into each PC-card and contains all of the information necessary for a host computer to correctly interact with the PC-card. The CIS contains, for example, information on the operating function of the PC-card, the card's manufacturer, its resource requirements, capabilities and compatibility and so on. The precise contents and formatting of the CIS are well known according to the PCMCIA standard and are not described further. The CIS is accessed from a dedicated memory region on the card called “attribute” memory.

When a PC-card is inserted into a host computer's receiving slot, its presence is identified to the computer by means of special card detection pins on an interface connector. That part of the host computer operating system which deals with PC-card interfacing, known as card services, then configures a host controller so that the attribute memory on the PC-card can be accessed via the host computer's bus. The host controller is a device that programmably connects the bus of the PC-card to the bus of the host computer. Having configured the host controller appropriately, card services then reads the CIS contained in the attribute memory on the PC-card to identify the card, its required resources and so on. The particular information required by a host computer can be very different for different types of PC-card. This makes the design of a rigorously formatted CIS impractical. For this reason a more general CIS data structure is used. The structure is defined within a Metaformat specification section of the PCMCIA standard. According to this standard, the CIS takes the form of linked-list of records of variable length. Card services, having parsed the CIS, can then take the necessary action to configure the PC-card, the host controller and the host computer. This will include, for example, initializing appropriate PC-card drivers into a working state. The CIS is crucial to the process of properly adding a PC-card's operating function to a host computer as a simple add-on expansion device.

PC-cards generally do not have an internal power source. This means that when a PC-card is not connected to a host computer, information stored in any of the volatile memory on the PC-card is lost. Accordingly, the CIS must be contained in an area of non-volatile memory, usually in a dedicated memory device.

In order for a host computer to be able to correctly access any area of the PC-card, including the CIS, it is also necessary for the PC-card to include some bus decode logic. The PC-card's bus decode logic operates to detect when, and to what area, a host computer is trying to access the PC-card. For the CIS to be accessible to a host computer, some bus decode logic is required to properly decode host bus access requests into accesses to the attribute memory. This aspect of the bus decode logic must also be non-volatile such that it is available when a PC-card is first connected to a host computer.

A PC-card will further include circuitry associated with its operating function, e.g. as a modem. This circuitry also needs to be accessible to the host computer bus, and further bus decode logic is required for this purpose. The bus decode logic, depending on the card type, would reside in the PC-card's “common memory” space or “input/output” (I/O) space.

FIG. 1 schematically shows a prior art PC-card 2 connected to a host computer 4. FIG. 1 shows how some of the different elements of the PC-card described above are physically distributed on known PC-cards. The PC-card comprises a printed circuit board 3 bearing a PC-card-bus 6 and separate areas of attribute memory (AM) 10, bus decode logic (BDL) 14, and operating function circuit (OFC) 16. The attribute memory is a parallel EEPROM and contains a card information structure (CIS) 12. The bus decode logic comprises conventional logic circuitry operable to decode host-bus accesses to both the attribute memory and the operating function circuit. The functions of the attribute memory, card information structure and bus decode logic will be understood from the above. The PC-card-bus interconnects the attribute memory, bus decode logic and operating function circuit. The PC-card-bus also connects the PC-card to a host-bus 8 of the host computer. The PC-card-bus-to-host-bus connection is via a host controller interface (not shown). The operation of this type of interface is well known from the PCMCIA standard. The operating function circuit contains circuitry specific to the particular type of device which is implemented on the PC-card, e.g. the operating function circuit will be the circuitry of a modem for a modem PC-card. For some types of device, e.g. modems, the PC-card will additionally have some input/output connectivity, as schematically indicated in FIG. 1 by an I/O connection 18.

As can be seen from FIG. 1, a conventional PC-card is constructed using various semiconductor packages as building blocks to form a final design. The individual semiconductor packages in FIG. 1 are identified as hatched areas in bold outline. A significant limitation on the freedom of a designer in designing a PC-card and the card's corresponding functional capabilities is imposed by the physical restraints on the PC-card size defined by the PCMCIA standard. This is especially so for CF-cards. The functional capabilities of a PC-card are often limited by the ability to fit the necessary components into one of the PCMCIA form factor standards.

### SUMMARY OF THE INVENTION

According to a one aspect of the invention, there is provided a semiconductor package for use in a peripheral device card connectable to a bus of a host computer the semiconductor package including: non-volatile memory for storing a card information structure; and bus decode logic.

The semiconductor package may be integrated in a peripheral device card and accordingly a further aspect of the invention provides a peripheral device card for connecting to a bus of a host computer, the card including; non-volatile memory for storing a card information structure; and bus decode logic; wherein the non-volatile memory and the bus decode logic are realized in a single semiconductor package.

In providing a single semiconductor package combining the card information structure and the bus decode logic, the task of a peripheral device card designer is made easier. The designer is relieved of the need to separately integrate these elements into his design and he is free to concentrate on other aspects of his design, for example those associated with an intended operating function of the card. Furthermore, in providing a single semiconductor package, the prototyping and testing of new designs of peripheral device cards is made easier. This leads to shorter development times and correspondingly shorter time-to-market times for newly designed cards.

In addition, by combining the card information structure and the bus decode logic in a single semiconductor package, a surface area of the PC card which must be set aside for the these elements is reduced. This provides the designer with more space for including operating function circuits, i.e. those circuits of a peripheral device card which are particular to its intended function. Size constraints associated with peripheral device cards frequently limit the functional capabilities of a card to that which can be squeezed into available circuit board area. By making more area available to a designer, peripheral device cards with improved functional capability can be designed and manufactured.

The combining of the non-volatile memory for storing the card information structure and the bus decode logic is particularly well suited for use with peripheral device cards which conform to a Personal Computer Memory Card International Association (PCMCIA) standard. The PCMCIA standard is commonly used throughout the peripheral device card industry and cards conforming to it are readily connectable to most modern personal computers. Nonetheless, the combining non-volatile memory for storing card information structure and bus decode logic in a single semiconductor package can also be applied to peripheral device cards based on other bus technologies, for example, newer bus technologies such as peripheral component interface (PCI) bus, PCI-express bus or universal serial bus (USB) standards. These device cards also require an area of non-volatile memory for storing plug-and-play information necessary to allow a host computer to integrate a connected device.

The non-volatile memory and bus decode logic may be realized in respective first and second chips in a multi-chip module or on a single semiconductor substrate.

Multi-chip module technology allows conventional non-volatile memory and bus decode logic semiconductor substrates to be combined in a single semiconductor package. Multi-chip technology requires only a further design of appropriate internal connections between individual semiconductor substrates. The relatively low capital investment associated with multi-chip technology makes it particularly useful in low or medium volume applications.

In higher volume applications, the increased flexibility provided by using a specifically designed single semiconductor substrate to combine the non-volatile memory and the bus decode logic in a single semiconductor package may outweigh the increased capital investment required with such a design approach.

In addition to the non-volatile memory and the bus decode logic, the single semiconductor package may further includes circuitry associated with an operating function of the card, for example a universal asynchronous receiver-transmitter (UART) operating function of the card.

UART functions are common in many peripheral device card applications. Because of this, a single semiconductor package combining the non-volatile memory for the card information structure and the bus decode logic which also provides a UART function is a very useful building block for peripheral device card designers. Such a building block simplifies the design of any remaining operation function circuit without significantly reducing the flexibility and wide applicability of the single semiconductor package.

In more specific applications, the peripheral device card may include a single semiconductor package providing all operating functions of the card.

### BRIEF DESCRIPTION OF THE DRAWINGS

For a better understanding of the invention and to show how the same may be carried into effect reference is now made by way of example to the accompanying drawings in which:

FIG. 1 is a block diagram which schematically shows the arrangement of elements of a prior art PC-card;

FIG. 2 is a block diagram which schematically shows the arrangement of elements of a PC-card according to a first embodiment of the invention;

FIG. 3 is a block diagram which schematically shows the arrangement of elements of a PC-card according to a second embodiment of the invention;

FIG. 4 is a block diagram which schematically shows the arrangement of elements of a PC-card according to a third embodiment of the invention; and

FIG. 5 is a block diagram which schematically shows the arrangement of elements of a PC-card according to a fourth embodiment of the invention.

### DETAILED DESCRIPTION

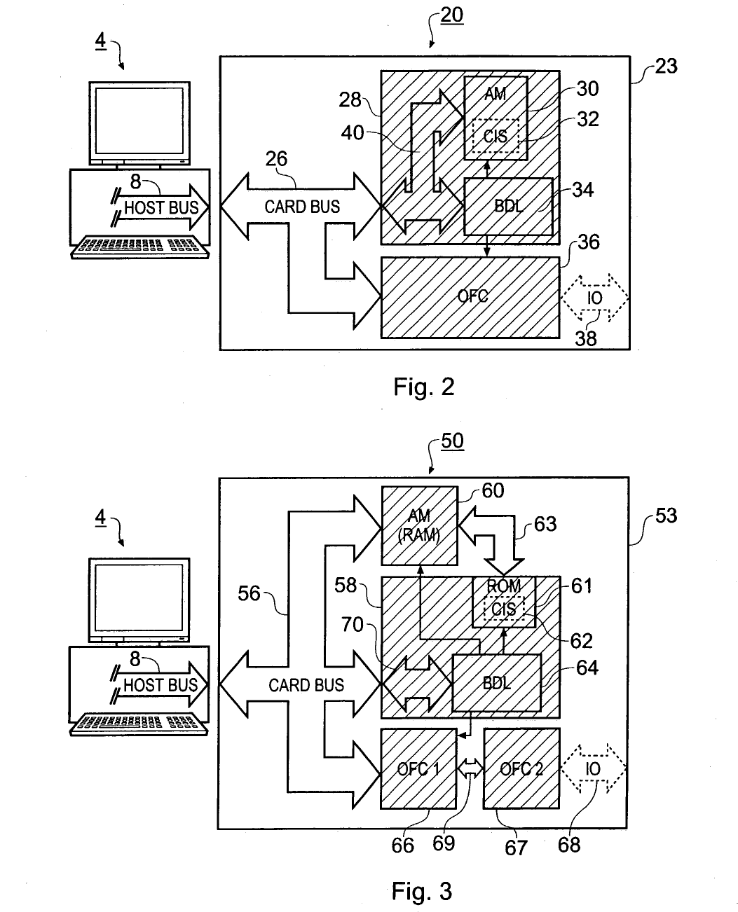

FIG. 2 schematically shows a PC-card 20 according to a first embodiment of the invention. The PC-card 20 is connected to a host computer 4. The host computer is a conventional computer capable of receiving PC-cards of the kind described above. FIG. 2 shows how different elements of the PC-card 20 are physically distributed. Individual semiconductor packages are identified as hatched areas in bold outline. The PC-card 20 comprises a printed circuit board 23 bearing a PC-card-bus 26, a bridging device 28 and an operating function circuit (OFC) 36. The PC-card-bus interconnects the bridging device 28 and the operating function circuit 36. The PC-card-bus also connects the PC-card to a host-bus 8 of the host computer. The PC-card-bus-to-host-bus connection is via a host controller interface (not shown). The operation of this interface conforms to and is well known from the PCMCIA standard. The operating function circuit 36 contains circuitry specific to the particular type of device which is implemented on the PC-card. In this example, the PC-card is a modem card and has input/output connectivity as schematically indicated by an I/O connection 38.

The bridging device 28 shown in FIG. 2 is a single semiconductor package which acts as a bridge between the host computer and the operating function circuit of the PC card. The bridging device contains an area of non-volatile attribute memory (AM) 30 and an area of bus decode logic (BDL) 34. The area of attribute memory is a parallel EEPROM and contains a card information structure (CIS) 32. Any other kind of non-volatile memory technology may also be used, for example serial EEPROM, FLASH memory, EPROM, one-time-programmable memory or otherwise volatile memory backed up by power source. The area of bus decode logic comprises logic circuitry operable to decode host-bus accesses to both the attribute memory and the operating function circuit in a conventional manner. The function of the attribute memory, the card information structure and the bus decode logic are similar to and will be understood from the description given above. The bridging device 28 further includes an internal bridging-device-bus 40. The internal bridging-device-bus interconnects the attribute memory 30, the bus decode logic 34 and the PC-card-bus 26. The internal bridging-device-bus 40 has the same architecture as the PC-card-bus.

The integration of the attribute memory and the bus decode logic into a single bridging device reduces the total number of semiconductor packages which must be fitted on to the printed circuit board 23. Since most of the physical size of a semiconductor package is taken up by its lead frame (i.e. its connection pins to the “outside” world), integrating the attribute memory and the bus decode logic provides a single semiconductor package size which is smaller than the combined size of the separate attribute memory and bus decode logic semiconductor packages found in conventional PC-cards. This is true even if the integrated semiconductor package requires the same number, or perhaps even a higher number, of connection pins. Nonetheless, in general an integrated semiconductor package will require a smaller number of connection pins than separate semiconductor packages, thus making an even greater space saving.

The single semiconductor package comprising the bridging device 28 in the example PC-card shown in FIG. 2 is a multi-chip module. Multi-chip module technology is a conventional technology which involves the integration of discrete semiconductor chips into a single semiconductor package with appropriate internal connectivity. Multi-chip module technology allows conventional semiconductor die substrates, e.g. conventional attribute memory semiconductor die substrates and bus decode logic circuitry semiconductor die substrates, to be used to create an integrated device. This reduces the capital investment required when in making newly designed integrated devices. The relatively low capital investment of multi-chip module technology makes it particularly well suited to low and medium volume applications. In higher volume applications it may be more appropriate and cost effective to design a single semiconductor substrate to provide the full functionality of the bridging device shown in FIG. 2.

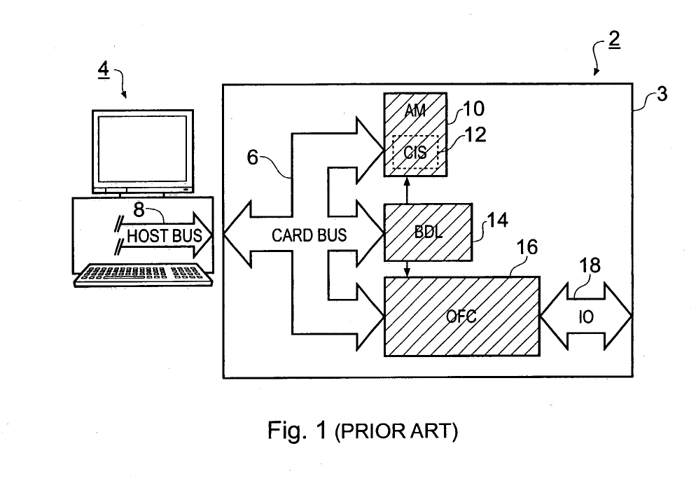

The reduction in surface area provided by using an integrated bridging device rather than the separate attribute memory and bus decode logic shown in FIG. 1, allows a PC-card designers to integrate more in the way of operation function circuitry into the otherwise limited space available on a PC-card's printed circuit board.

FIG. 3 schematically shows a PC-card 50 according to a second embodiment of the invention. The PC-card 50 is connected to a host computer 4. The host computer is a conventional computer capable of receiving PC-cards. FIG. 3 shows how different elements of the PC-card 50 are physically distributed on the PC-card. Individual semiconductor packages are identified as hatched areas in bold outline. The PC-card 50 comprises a printed circuit board 53 bearing a PC-card-bus 56, a bridging device 58, an area of attribute random access memory (attribute RAM) 60, a primary operating function circuit (OFC1) 66 and a secondary operating function circuit (OFC2) 67. The PC-card-bus 56 interconnects the bridging device 58, the attribute RAM 60 and the primary operating function circuit 66. The PC-card-bus also connects the PC-card to a host-bus 8 of the host computer. The PC-card-bus-to-host-bus connection is as described above. The primary and secondary operating function circuits combine to provide an overall function of a device implemented on the PC-card. In this example, the PC-card is again a modem. The necessary circuitry for providing the modem function is split between the primary and secondary operating function circuits. In the example shown in FIG. 2, the primary operating function circuit 66 is a single semiconductor package universal asynchronous receiver/transmitter (UART). The primary operating function circuit behaves as an interface between the parallel PC-card bus 56 and the secondary operating function circuit 67, which contains the remaining necessary circuitry to provide the modem function. The primary and secondary operating function circuits are connected by connection 69. While two operating function circuits are shown in FIG. 2, in other examples any number of discrete operating function circuits, and associated semiconductor packages, may be used depending on the design of the particular device implemented on the PC-card. Since it is a modem, the PC-card of FIG. 2 additionally has input/output connectivity. This is schematically indicated by an I/O connection 68.

The bridging device 58 shown in FIG. 3 is again a single semiconductor package. The bridging device contains an area of read only memory (ROM) 61 and an area of bus decode logic (BDL) 64. The area of ROM 61 is a serial EEPROM and contains a card information structure (CIS) 62. The area of bus decode logic comprises logic circuitry operable to decode host-bus accesses to the ROM 61, the attribute RAM 60 and the primary operating function circuit 66. The functions of the card information structure and the bus decode logic are similar to and will be understood from the descriptions given above. The bridging device 58 further includes an internal bridging-device-bus 70. The internal bridging-device-bus connects the bus decode logic 64 and the PC-card-bus 56. The internal bridging-device-bus 70 has the same architecture as the PC-card-bus.

In the PC-card shown in FIG. 3, the CIS is stored in serially accessed non-volatile ROM, while the attribute memory accessed by the host computer is a volatile parallel access RAM memory. Because of this, the CIS must be loaded from the serial EEPROM ROM 61 into the attribute RAM 60 when the card is first inserted into the host computer or after a reset cycle. This is done by using control logic (not shown) which copies the contents of the serial-access ROM into the parallel-access attribute RAM via a ROM-RAM connection 63. PCMCIA conformant bus speeds are such that accesses by the host computer to attribute memory in a PC-card cannot realistically be performed serially in real time. A serial device is typically an order of magnitude too slow because a high number of timing cycles are needed to access and read data. Accesses to the attribute memory on a PC-card also tend to be non-sequential and this further hinders direct access to a serial ROM. By first copying data from the serial ROM into the parallel attribute RAM, these problems are avoided.

As with the first embodiment, the bridging device of FIG. 3 is a multi-chip module, although as before its functionality could also be more fully integrated in a single semiconductor substrate design.

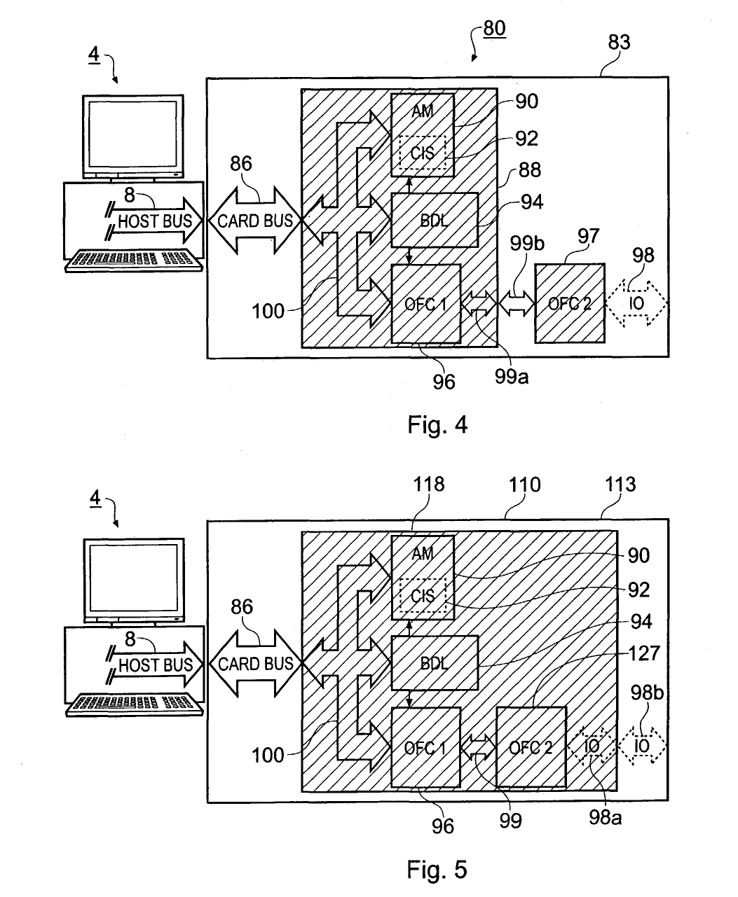

FIG. 4 schematically shows a PC-card 80 according to a third embodiment of the invention. The PC-card 80 is connected to a host computer 4. Individual semiconductor packages are identified as hatched areas in bold outline. The PC-card 80 comprises a printed circuit board 83 bearing a PC-card-bus 86, a bridging device 88 and a secondary operating function circuit (OFC2) 97. The PC-card-bus connects to the bridging device 88 and to a host-bus 8 of the host computer 4 as described above. The secondary operating function circuit 97 contains circuitry specific to the particular type of device which is implemented on the PC-card. In this example, the PC-card is a modem card and has input/output connectivity as schematically indicated by an I/O connection 98. The secondary operating function circuit 97 is similar to the secondary operating function circuit 67 shown in FIG. 3 and described above. The secondary operating function circuit does not provide all of the functionality of the PC-card, which is again a PC modem card. The secondary operating function circuit does not include a UART element necessary for the PC-card to function as a modem. The UART element is instead provided by a primary operating function circuit 96 within the bridging device 88.

The bridging device 88 shown in FIG. 4 is again a single semiconductor package. The bridging device contains an area of non-volatile attribute memory 90, an area of bus decode logic 94 and the primary operating function circuit 96 referred to above. The primary operating function circuit is connected to the secondary operating function circuit in a manner appropriate to the respective functions they perform by connections 99a and 99b. The area of attribute memory is a parallel EEPROM and contains a card information structure 92. The area of bus decode logic comprises logic circuitry operable to decode host-bus accesses to both the attribute memory and the primary operating function circuit in a conventional manner. The function of the attribute memory, the card information structure and the bus decode logic are similar to and will be understood from the descriptions given above. The bridging device 88 further includes an internal bridging-device-bus 100. The internal bridging-device-bus interconnects the attribute memory 90, the bus decode logic 94, the primary operating function circuit 96 and the PC-card-bus 86. The internal bridging-device-bus has the same architecture as the PC-card-bus.

The PC-card of the third embodiment differs from that of FIG. 2 in that the operating function circuit 36 of FIG. 2 is replaced by primary and secondary operating function circuits, the primary one of which is included within the bridging device. In this example, the attribute memory 90, the bus decode logic 94 and the primary operating circuit 96 are again separate semiconductor chips are combined in a multi-chip module to form the bridging device 88. As before, however, it may be preferable, for example in high volume applications, to design a specific single semiconductor substrate for the bridging device. A single semiconductor substrate bridging device might be, for example, an application specific integrated circuit (ASIC) or an appropriately configured field-programmable gate array (FPGA).

While the PC-cards of FIGS. 2 and 4 can provide the same functionality using the same number of separate semiconductor packages, the benefit of the design approach employed in FIG. 3, i.e. that of integrating part of the overall operating function circuit into the bridging device, is that the bridging device then provides a more functional building block for use in other PC-card designs. By including an operating function circuit commonly used in many different types of PC-card, such as a UART function, a single semiconductor package bridging device can be used to simplify the design of a PC-card's further operating function circuit without sacrificing the design flexibility provided by a “building-block” approach. The design approach used for the PC-card shown in FIG. 4 provides a reduced semiconductor package size for the non-unique circuitry on a PC-card, thus allowing more space, and correspondingly more functional capability, for circuitry which is more specific to individual PC-card types. As with all embodiments, it would not be necessary for a manufacturer to build and supply complete PC-cards. Instead, a manufacturer could simply supply bridging devices as single semiconductor packages for use by others as building blocks to be used in the manufacture of PC-cards.

FIG. 5 schematically shows a PC-card 110 according to a fourth embodiment of the invention. The PC-card 110 is connected to a host computer 4. Individual semiconductor packages are again identified as hatched areas in bold outline. The PC-card 110 comprises a printed circuit board 113 bearing a PC-card bus 86 and a bridging device 118. Many of the features shown in FIG. 5 are similar to and will be understood from the correspondingly numbered features shown in FIG. 4. However, the secondary operating function circuit 97 of the embodiment shown in FIG. 4 is replaced in the fourth embodiment by secondary operating function circuit 127 which is integrated into the bridging device 118. The primary and secondary operating function circuits are appropriately connected by connection 99. Appropriate input/output connectivity for the secondary operating function circuit is provided by I/O connections 98a and 98b. By integrating all of a PC-cards functions into a single chip, a high level of functional capability can be achieved in a single small size semiconductor package, though at a cost of limited flexibility. The bridging device 118 may again be a multi-chip module, a specifically designed single semiconductor substrate or use any other semiconductor chip integration technology.

While much of the above description is directed to a modem PC-card as a common example of a peripheral device implemented on a PC-card, it will be appreciated that the invention is equally applicable to any other kind of PC-card, for example, memory cards, hard disk cards, ethernet cards, serial and/or parallel port interface cards, sound cards, video cards, CD-ROM interface cards, SCSI interface cards, cellular telephone interface cards, security token cards, docking station interface cards, global positioning system cards, local area network cards, infrared adapter cards, ISDN cards, joystick interface cards and so on.

While the above description has concentrated on PCMCIA conformant peripheral device cards, it will be understood that similar techniques can be applied to other peripheral devices requiring non-volatile memory to store ‘plug-and-play’ data structures necessary for a host to properly accept the peripheral device. Other devices may be conformant to any of the peripheral component interconnect (PCI) bus standard, the PCI-express bus standard or the universal serial bus (USB)/firewire bus standards, for example.

What is claimed is:

1. A semiconductor package for use in a peripheral device card connectable to a bus of a host computer the semiconductor package including:
non-volatile memory for storing a card information structure; and
bus decode logic.

2. A semiconductor package accordingly to claim 1, wherein the semiconductor package provides functions conformant with a Personal Computer Memory Card International Association (PCMCIA) standard.

3. A semiconductor package according to claim 1, wherein the semiconductor package is a multi-chip module with the non-volatile memory and the bus decode logic being realized in respective first and second chips of the multi-chip module.

4. A semiconductor package according to claim 1, wherein the non-volatile memory and bus decode logic are realized on a single semiconductor substrate.

5. A semiconductor package according to claim 1, wherein the semiconductor package further includes circuitry associated with an operating function.

6. A semiconductor package according to claim 5, wherein the circuitry provides a universal asynchronous receiver-transmitter (UART) operating function.

7. A peripheral device card for connecting to a bus of a host computer, the card including:
non-volatile memory for storing a card information structure; and
bus decode logic; wherein the non-volatile memory and the bus decode logic are realized in a single semiconductor package.

8. A peripheral device card accordingly to claim 7, wherein the card conforms to a Personal Computer Memory Card International Association (PCMCIA) standard.

9. A peripheral device card according to claim 7, wherein the non-volatile memory and the bus decode logic are realized in respective first and second chips in a multi-chip module.

10. A peripheral device card according to claim 7, wherein the first and second areas of non-volatile memory are realized on a single semiconductor substrate.

11. A peripheral device card according to claim 7, wherein the single semiconductor package further includes circuitry associated with an operating function of the card.

12. A peripheral device card according to claim 12, wherein the circuitry provides a universal asynchronous receiver-transmitter (UART) operating function of the card.

13. A peripheral device card according to claim 12, wherein the circuitry provides all operating functions of the card.
